(19) United States
(12) Patent Application Publication
(10) Pub. No.: US 2026/0038162 A1
(43) Pub. Date: Feb. 5, 2026

(54) ELECTRONIC DEVICE FOR MODIFYING IMAGE AND OPERATING METHOD AND STORAGE MEDIUM THEREOF

(71) Applicant: SAMSUNG ELECTRONICS CO., LTD., Suwon-si (KR)

(72) Inventors: Jiyoun HAN, Suwon-si (KR); Sowoon BAE, Suwon-si (KR); Yoojin WON, Suwon-si (KR); Haeri LEE, Suwon-si (KR); Minseok HAN, Suwon-si (KR)

(73) Assignee: SAMSUNG ELECTRONICS CO., LTD., Suwon-si (KR)

(21) Appl. No.: 19/279,262

(22) Filed: Jul. 24, 2025

Related U.S. Application Data
(63) Continuation of application No. PCT/KR2025/010514, filed on Jul. 17, 2025.

(30) Foreign Application Priority Data
Jul. 31, 2024 (KR) 10-2024-0101888

(51) Int. Cl. G06T 11/00; G06F 40/166

(52) U.S. Cl. CPC G06T 11/00; G06F 40/166

(57) ABSTRACT

An electronic device may include a display, one or more processors, and memory storing instructions. The instructions, when executed by the one or more processors individually or collectively, may cause the electronic device to provide an image and texts that describe the image, change a first text, included in the texts, to a second text based on a user input, and provide a modified image in which an object is generated, removed, or modified based on the second text.

### CROSS-REFERENCE TO RELATED APPLICATIONS

This application is a by-pass continuation application of International Application No. PCT/KR2025/010514, filed on Jul. 17, 2025, which is based on and claims priority to Korean Patent Application No. 10-2024-0101888, filed in the Korean Intellectual Property Office on Jul. 31, 2024, the disclosures of which are incorporated by reference herein in their entireties.

### BACKGROUND

### 1. Field

The disclosure relates to an electronic device for modifying an image and an operating method and a storage medium thereof.

### 2. Description of Related Art

An image processing technology plays an important role in advertising, entertainment, and social media content production. An existing image modification has been processed manually, for example, but recent advances in artificial intelligence technology have enabled automated image editing.

For example, image modification, such as changing, adding, and/or deleting objects in an image, may be performed using an artificial intelligence model. During the image modification, for example, for object recognition and/or classification, the artificial intelligence model (for example, a convolution neural network (CNN) model) may be used. The CNN model may be used to recognize and classify each object by training a visual feature of an image. Accordingly, various objects in the image may be recognized. During the image modification, for example, for changing, adding, and/or deleting the objects, a generative adversarial network (GAN) model may be used. The GAN model may be composed of two networks, i.e., a generator and a discriminator. The generator attempts to generate natural results in a process of adding or changing the objects in the image, and the discriminator may determine how close the generated image is to reality, thereby enabling natural image modification. Meanwhile, in addition to the artificial intelligence model described above, various artificial intelligence models, such as an auto encoder, a transformer, and/or the like, may be used for the image modification.

The above information may be provided as a related art for the purpose of aiding understanding of the disclosure. No claim or determination has been made as to whether any of the foregoing may be applied as a prior art related to the disclosure.

### SUMMARY

In one or more embodiments of the present disclosure, an electronic device may include: a display; one or more processors; and memory storing instructions. The instructions, when executed by the one or more processors individually or collectively, may cause the electronic device to: provide an image and texts that describe the image, change a first text, included in the texts, to a second text based on a user input, and provide a modified image in which an object is generated, removed, or modified based on the second text.

In one or more embodiments of the present disclosure, there is provided a non-transitory computer-readable storage medium storing one or more instructions, when executed by one or more processors of an electronic device individually or collectively, causing the electronic device to perform: providing an image and texts that describe the image; changing a first text, included in the texts, to a second text based on a user input; and providing a modified image, in which an object is generated, removed, or modified based on the second text.

In one or more embodiments of the present disclosure, an operating method of an electronic device may include: providing an image and texts that describe the image; changing a first text, included in the texts, to a second text based on a user input; and providing a modified image in which an object is generated, removed, or modified based on the second text.

### BRIEF DESCRIPTION OF THE DRAWINGS

FIG. 1 is a block diagram illustrating an electronic device according to an embodiment.

FIG. 2 is a flowchart for describing an operating method of an electronic device according to an embodiment.

FIG. 3A is an example of a screen provided according to various embodiments.

FIG. 3B is an example of a screen provided according to various embodiments.

FIG. 3C is an example of a screen provided according to various embodiments.

FIG. 4A is a flowchart for describing an operating method of an electronic device according to an embodiment.

FIG. 4B is a drawing for describing text provision according to various embodiments.

FIG. 4C is a drawing for describing text provision according to various embodiments.

FIG. 5A is a flowchart for describing an operating method of an electronic device according to an embodiment.

FIG. 5B is a diagram for describing candidate selection according to an embodiment.

FIG. 6 is a flowchart for describing an operating method of an electronic device according to an embodiment.

FIG. 7A is a flowchart for describing an operating method of an electronic device according to an embodiment.

FIG. 7B is a drawing for describing object addition according to an embodiment

FIG. 8 is a diagram for describing image modification by an electronic device according to an embodiment.

FIG. 9 is a diagram for describing image modification by an electronic device according to an embodiment.

FIG. 10 is a diagram for describing image modification by an electronic device according to an embodiment.

FIG. 11 is a diagram for describing image modification by an electronic device according to an embodiment.

FIG. 12 is a diagram for describing image modification by an electronic device according to an embodiment.

FIG. 13A is a diagram for describing image modification by an electronic device according to an embodiment.

FIG. 13B is a diagram for describing image modification by an electronic device according to an embodiment.

FIG. 14 is a diagram for describing image modification by an electronic device according to an embodiment.

FIG. 15A is a diagram for describing image modification by an electronic device according to various embodiments.

FIG. 15B is a diagram for describing image modification by an electronic device according to various embodiments.

### DETAILED DESCRIPTION

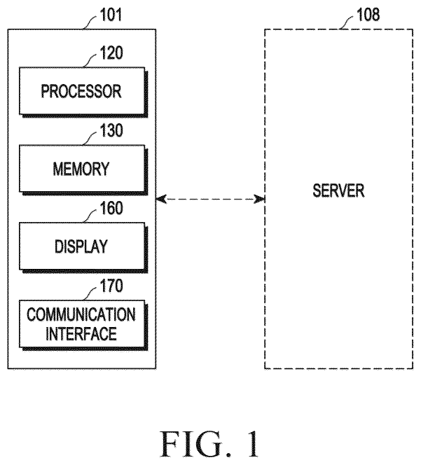

FIG. 1 is a block diagram illustrating an electronic device according to an embodiment.

According to an embodiment, an electronic device 101 may include a processor 120, memory 130, and/or a display 160. In some embodiments, at least one of these components may be omitted in the electronic device 101, or one or more other components may be added in the electronic device 101. In some embodiments, some of these components may be integrated into one component, and there is no limitation on implementation thereof. For example, the electronic device 101 may perform at least some of operations described in the disclosure in conjunction with a server 108. This operational configuration may be referred to as a non-standalone (NSA) mode, wherein computational tasks, data processing, or model inference may be partially or fully offloaded to the server 108 over a network (e.g., Wi-Fi, 5G, or other communication interfaces). For example, the electronic device 101 may perform at least some of the operations described in the disclosure independently, without being associated with the server 108. This configuration may be referred to as a standalone (SA) mode or an on-device mode. Those skilled in the art will appreciate that each of the operations described in the disclosure may be performed by the electronic device 101, by the server 108, or by both entities.

The processor 120 may execute, for example, at least one instruction stored in the memory 130. The memory 130 may store the at least one instruction, and the at least one instruction may be executed by the processor 120. For example, the memory 130 may include non-volatile memory and/or volatile memory, and there is no limitation. The memory 130 may include a hard disk, a read-only memory (ROM), a random access memory (RAM), a cache memory, and/or a register, and there is no limitation on implementation thereof. Some of the entities described above (for example, it may be a register, but there is no limitation) may be implemented as a part of the processor 120, and there is no limitation on their implementation form. The at least one instruction, when executed by the processor 120, may cause the electronic device 101 to perform at least one operation. For example, as the at least one instruction is executed, at least one other component may be controlled, and/or various data processing or calculations may be performed. As at least a part of the data processing or calculation, the processor 120 may store a command or data received from other components in at least a part of the memory 130, process the command or data stored in the memory 130, and store result data in the memory 130. The processor 120 may include a main processor (e.g., a central processing unit) including circuitry, or an auxiliary processor (e.g., a graphics processing device, a neural network processing device, an image signal processor, a sensor hub processor, or a communication processor) which may be operated independently or together therewith. For example, performance of a particular operation may mean that a particular operation is performed by (or under the control of) one entity (e.g., the main processor). For example, the particular operation being performed may mean that the particular operation is performed by (or under the control of) a plurality of entities (for example, it may be a main processor and one or more auxiliary processors, but there is no limitation). For example, a plurality of operations being performed may mean that, for example, all of the plurality of operations are performed by (or under the control of) a single entity (e.g., a main processor). For example, the plurality of operations being performed may mean that some of the plurality of operations are performed by at least one entity, and the remaining operations are performed by at least one other entity. Meanwhile, at least one instruction for performing the particular operation may be stored in one memory, or may be stored in a distributed manner in each of a plurality of memories.

The display 160 may visually provide information to the outside (e.g., a user) of the electronic device 101. For example, if the electronic device 101 is implemented as a smart phone, a tablet PC, a video see through (VST) device, or a head-mounted display (HMD), the display 160 may be implemented to include, for example, a liquid crystal display (LCD) and a control means (for example, a display driving integrated circuit (DDI)). The display 160 may further include a touch screen panel (TSP) for touch sensing and/or a control means (for example, a TSP integrated circuit (TSP IC)). For example, if the electronic device 101 is implemented as an augmented reality (AR) glasses device, the display 160 may be implemented to include, for example, a light irradiation device, an optical waveguide, and/or a control means. The processor 120 may control the display 160 to express an object. An expression of the object may refer to the visual presentation, rendering, or representation of a digital or graphical object on a display, and will be described in further detail later. For example, the processor 120 may generate and transmit control data to the display 160 to initiate or manage the expression of the object, and this may be expressed that the processor 120 controls the display 160.

Meanwhile, although not separately illustrated in FIG. 1, the electronic device 101 may further include a communication interface 170. The communication interface 170 may be implemented by any one or any combination of a digital modem, a radio frequency (RF) modem, a communication circuit, an antenna circuit, a WiFi chip, and related software and/or firmware. The electronic device 101 may transmit/receive data to/from an external electronic device, for example, the server 108, via the communication interface 170. The electronic device 101 may, for example, request a server to perform some or all of operations performed by the electronic device 101 in various embodiments of the disclosure, and may receive a performance result in response to the request. As will be described in more detail below, the electronic device 101 may perform provision of a text for describing an object included in an image, modification of a portion of the text, and/or image modification based on the modification. The electronic device 101 may request, from the server 108, the provision of the text for describing the object included in the image, the modification of the portion of the text, and/or the image modification based on the modification, and may receive a performance result in response to the request. The electronic device 101 may provide a performance result for a function based on the performance result received from the server 108.

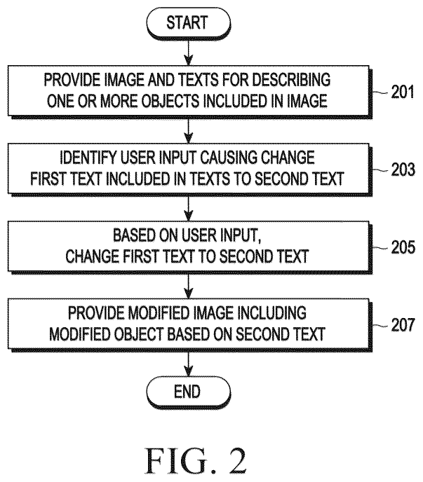

FIG. 2 is a flowchart illustrating an operating method of an electronic device according to an embodiment.

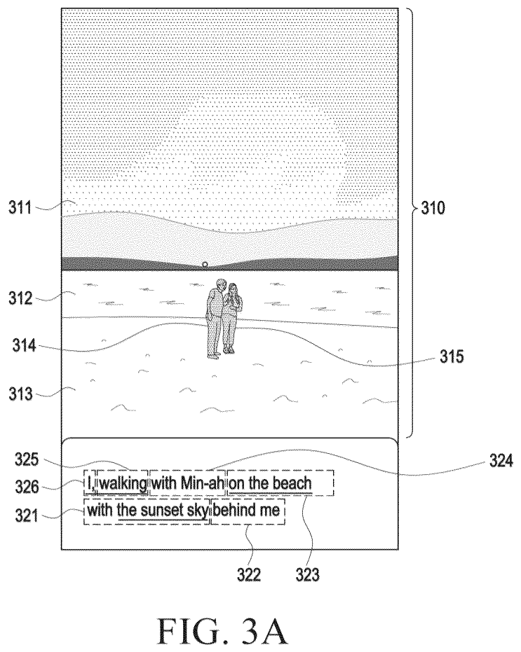

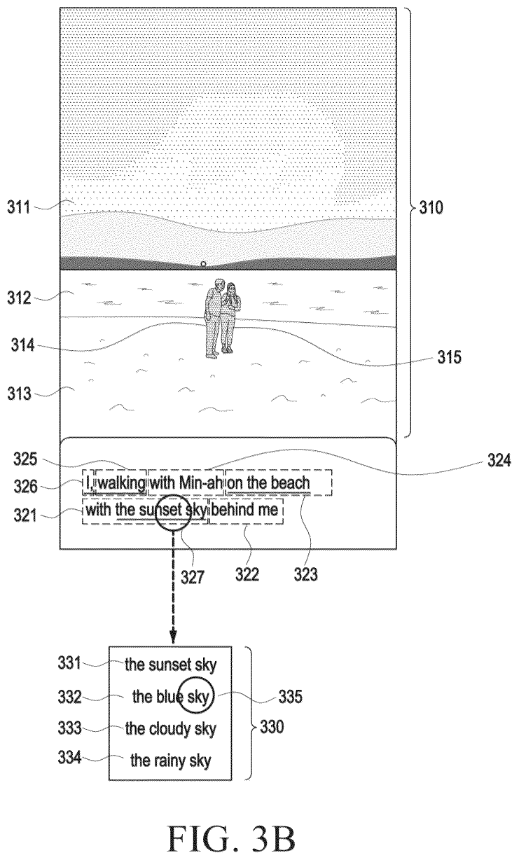

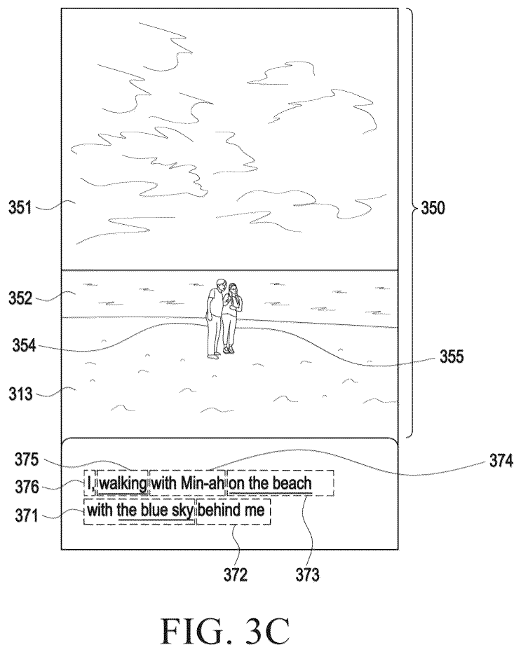

An embodiment in FIG. 2 will be described with reference to FIGS. 3A, 3B, and 3C.

FIG. 3A is an example of a screen provided according to various embodiments.

FIG. 3B is an example of a screen provided according to various embodiments.

FIG. 3C is an example of a screen provided according to various embodiments.

According to an embodiment, an electronic device 101 may, in operation 201, provide an image 310 and texts 321, 322, 323, 324, 325, and 326 for describing one or more objects 311, 312, 313, 314, and 315 included in the image 310 as shown in FIG. 3A. The term “text” may refer to a character, a word, a phrase, or a sentence. For example, the electronic device 101 may provide the texts 321, 322, 323, 324, 325, and 326 based on an editing request for the image 310, but those skilled in the art will understand that this is exemplary and that there is no limitation to a provision event for the texts 321, 322, 323, 324, 325, and 326. The electronic device 101 may display a sentence or phrase (e.g., “I, walking with Min-ah on the beach with the sunset sky behind me”) that provides an overall description of the image 310, along with visual segmentations corresponding to individual texts 321, 322, 323, 324, 325, and 326. For example, the electronic device 101 may show bounding boxes around the texts 321, 322, 323, 324, 325, and 326, allowing the user to select one or more for editing.

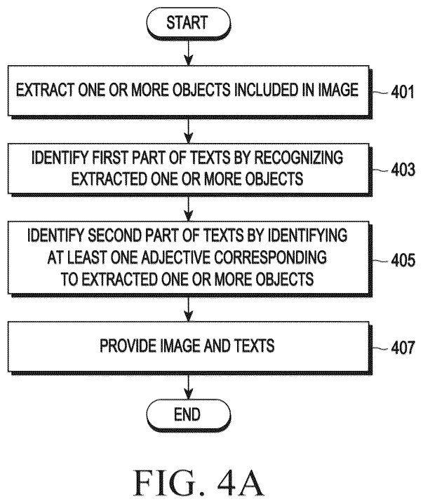

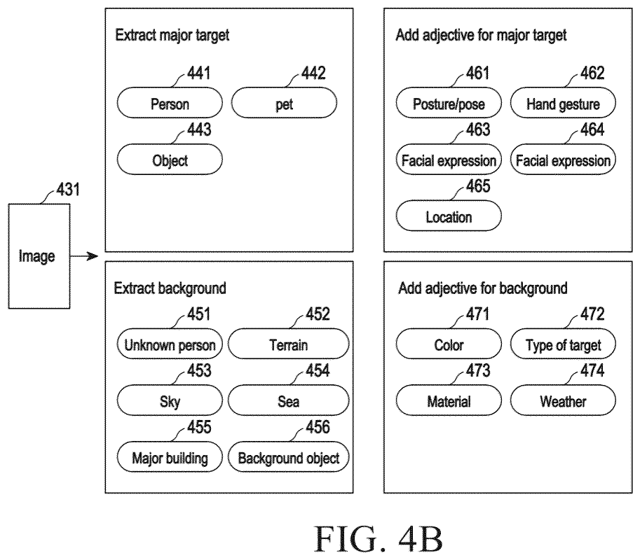

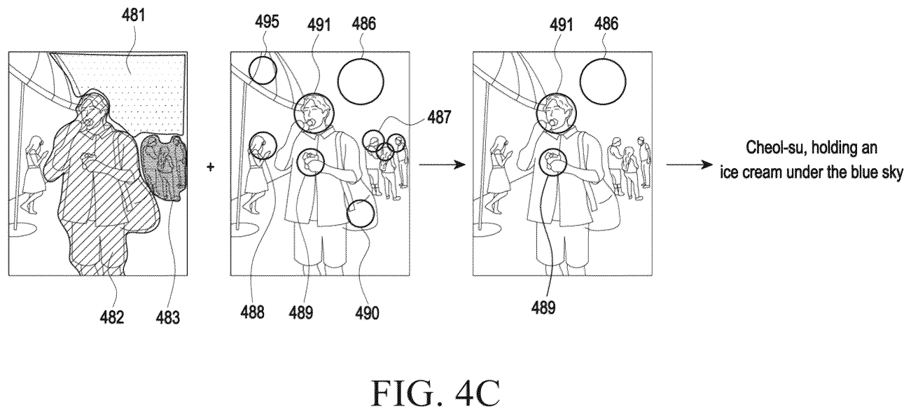

In an embodiment in FIG. 3A, the image 310 and the texts 321, 322, 323, 324, 325, and 326 are illustrated as being provided together on the same display screen, but this is exemplary. The image 310 and the texts 321, 322, 323, 324, 325, and 326 may be provided separately in different display screens, and there is no limitation on a provision order thereof. In an embodiment shown in FIG. 3A, the texts 321, 322, 323, 324, 325, and 326 are illustrated as being provided so as not to overlap with the image 310, but this is exemplary. For example, those skilled in the art will appreciate that the texts 321, 322, 323, 324, 325, and 326 may be expressed to be positioned on at least a portion of the image 310. For example, based on extraction of an object from an image, recognition of the extracted object, and/or provision of a recognition result, a text describing the object included in the image may be provided. The provision of the text describing the object included in the image may be provided, for example, as an inference result of artificial intelligence, and for example, an artificial intelligence model may include, but is not limited to, a residual network (ResNet), a visual geometry group network (VGGNet), an inception network (Inception), You Only Look Once (YOLO), Faster region-based convolutional neural network (R-CNN), Mask R-CNN, or a Scene Recognition model. The provision of the text will be described with reference to FIGS. 4A, 4B, and 4C.

For example, referring to FIG. 3A, a text (e.g., “I, walking with Min-ah on the beach with the sunset sky behind me”) corresponding to the image 310 may include a first part 321 corresponding to an object 311 in the image 310. For example, the first part 321 may be determined based on a recognition result for the object 311 being “the sunset sky.” The text corresponding to the image 310 may include a third part 323 corresponding to a plurality of objects 312 and 313. For example, a text “the beach” may be identified based on the recognition result for the objects 312 and 313 being the sea and the ground, and a text “on” may be identified based on an attribute of the corresponding text being a place. For example, the text corresponding to the image 310 may include a fourth part 324 corresponding to an object 314. The text of “Min-ah” may be identified based on the recognition result for the object 314 being identified as a person stored as “Min-ah”, and a text “with” may be identified based on existence of a plurality of persons. The text corresponding to the image 310 may include a sixth part 326 corresponding to an object 315. A text “I” may be identified based on a recognition result for the object 315 being identified as a person stored as a “user.” The text corresponding to the image 310 may include a second part 322 and a fifth part 325 which are identified based on a relationship among the objects 312, 313, 314, and 315. For example, the second part 322 may be identified based on a depth value of the object 314 or 315 being smaller than a depth value of the object 311 and a part of the object 314 or 315 being recognized as a face (or, a front view of a human being). For example, based on a relationship between the third part 323 of “on the beach” and the texts 324, 326 corresponding to persons, a fifth part 325 of a verb form such as “walking” may be identified. The object recognition processes for identifying objects 311, 312, 313, 314, and 315, and the identification of texts 321, 322, 323, 324, 325, and 326 corresponding to those objects, may be performed by the electronic device 101 either in standalone mode or in cooperation with the server 108.

In an embodiment, if some of the texts are modifiable and others are not modifiable, the electronic device 101 may, but is not limited to, express the texts which are modifiable among the texts 321, 322, 323, 324, 325, and 326 as being distinct from other parts. Those skilled in the art will understand that the electronic device 101 may be implemented to support modification corresponding to all texts.

The electronic device 101 may, in operation 203, identify a user input causing a change of a first text included in the texts to a second text. The electronic device 101 may change the first text to the second text based on the user input in operation 205. For example, the electronic device 101 may provide a plurality of replaceable candidates 331, 332, 333, and 334 based on a user input 327 for the first text 321 as shown in FIG. 3B. There is no limitation on a provision location and/or an expressing scheme of a list 330 including the plurality of candidates 331, 332, 333, and 334. Based on selection 335 of the second text 332 among the plurality of candidates 331, 332, 333, and 334 being identified, the electronic device 101 may change the first text to the second text. For example, the electronic device 101 may change the first text to the second text based on an input of the user (for example, it may be, but not limited to, an input via a soft input panel (SIP)) for the second text for replacing the first text. The soft input panel (SIP) may refer to an on-screen keyboard or virtual keyboard that allows text input without physical keys. In some embodiments, the electronic device 101 may change the first text to the second text based on an analysis result of a user voice from the user.

The electronic device 101 may, in operation 207, provide a modified image 350 including a modified object 351 based on the second text 371, as shown in FIG. 3C. The modified image 350 may include “the blue sky” instead of “the sunset sky” as the modified object 351 based on the second text 371. In this example, an attribute (for example, it may be, but not limited to, a color, brightness, and/or a chroma) of an object based on a selected text may be changed. For example, although it has been described that a shape of the object is maintained but the attribute is changed, this is exemplary and there is no limitation thereto. The modified object 351 may be provided based on, for example, an inference result of an artificial intelligence model, but there is no limitation thereto. For example, the electronic device 101 may input a prompt with intent for changing the first text to the second text and the image 310 before modification into a generative artificial intelligence model. While FIG. 3C illustrates an example of modifying an existing object in the original image, the embodiments of the present disclosure are not limited to this. A modified image may also be generated by adding a new object to the original image, for example, by replacing the first text 321 with the second text 371.

According to an embodiment, the generative artificial intelligence model may provide the image 350 including the modified object 351. The generative AI model may include, for example, a generative adversarial network (GAN), a conditional GAN, Pix2pix, a CycleGAN, or Deep image matting, and there is no limitation on a type thereof. The remaining objects 352, 353, 354, and 355 of the modified image 350 may be identical to the objects 312, 313, 314, and 315 of the image 310 before the modification, respectively, and/or may be generated by modifying some of the objects 312, 313, 314, and 315 of the image 310 before the modification. For example, those skilled in the art will understand that a degree of contrast of persons under the blue sky and a degree of contrast of persons under the sunset sky may be different, and each of the objects 352, 353, 354, and 355 may be modified based on correction of the object 351, or may be maintained.

FIG. 4A is a flowchart illustrating an operating method of an electronic device according to an embodiment.

An embodiment in FIG. 4A will be described with reference to FIGS. 4B and 4C.

FIG. 4B is a drawing for describing text provision according to various embodiments.

FIG. 4C is a drawing for describing text provision according to various embodiments.

According to an embodiment, an electronic device 101 may, in operation 401, extract one or more objects included in an image 431 such as shown in FIG. 4B. The electronic device 101 may recognize one or more objects. Segmentation and/or recognition of a segmented object may be performed based on, for example, an Otsu's method, an edge detection method, a region based method, a k-means clustering method, a random forest method, fully convolutional networks (FCN), a U-Net method, a SegNet method, a Mask R-CNN method, a DeepLab method, a PSPNet method, a high-resolution network (HRNet) method, a dellLabv3 method, a Semantic segmentation networks method (deeplab, PSPNet), an instance segmentation network (PANet, YOKACT), a transformer-based model (DETR, Swin transformer method), a graph-based method (GCN), an attention method (self-attention, non-local networks), multi-task learning (multi-task networks), etc., but there is no limitation on the method.

The electronic device 101 may identify a first part of texts by recognizing the extracted one or more objects in operation 403. The electronic device 101 may identify the second part of the texts by identifying at least one adjective corresponding to the extracted one or more objects in operation 405. For example, referring to FIG. 4B, the electronic device 101 may recognize, from an image 431, an object 441 corresponding to a character, an object 442 corresponding to a pet, and another object 443. The electronic device 101 may recognize, from the image 431, an object 451 corresponding to an unknown person (a person with no known recognition result), an object 452 corresponding to terrain, an object 453 corresponding to the sky, an object 454 corresponding to the sea, an object 455 corresponding to a major building, or an object 456 corresponding to a background. Each object may be recognized based on an artificial intelligence model specialized and trained corresponding to a corresponding object and/or a general-purpose image recognition model, and there is no limitation on a type and/or number of artificial intelligence models thereof.

The electronic device 101 may identify features 461, 462, 463, 464, 465, 471, 472, 473, and 474 associated with objects 441, 442, 443, 451, 452, 453, 454, 455, and 456. The features 461, 462, 463, 464, 465, 471, 472, 473, and 474 may be, for example, but are not limited to, a text of an adjective to modify the objects 441, 442, 443, 451, 452, 453, 454, 455, and 456. For example, the features 461, 462, 463, 464, 465, 471, 472, 473, and 474 may be identified as part of a recognition result for an object. Alternatively or additionally, those skilled in the art will understand that the features 461, 462, 463, 464, 465, 471, 472, 473, and 474 may be identified based on an inference result of an additional artificial intelligence model for the recognition result for the object. For example, an artificial intelligence model for recognizing a posture/pose, which is the feature 461, may be implemented independently from an artificial intelligence model for identifying a type of the object, or may be implemented as one artificial intelligence model. Those skilled in the art will understand that the electronic device 101 may select an artificial intelligence model to be additionally used according to a type of an identified object if the artificial intelligence model for recognizing the feature is independent from the artificial intelligence model for identifying the type of the object.

The electronic device 101 may provide images and texts in operation 407. For example, as shown in FIG. 4C, a recognition result for the object 485, 486, 487, 488, 489, 490, or 491 may be identified based on a segmentation result 481, 482, or 483. The electronic device 101 may also identify a feature (e.g., a color of the sky is blue, etc.) of the object 485, 486, 487, 488, 489, 490, or 491 as described above. The electronic device 101 may identify the text 495 corresponding to the image 431 based on a recognition result for the object, the feature of the object, and/or a relationship between the objects.

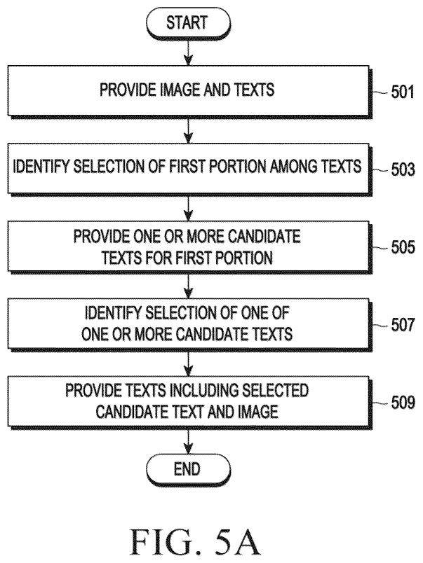

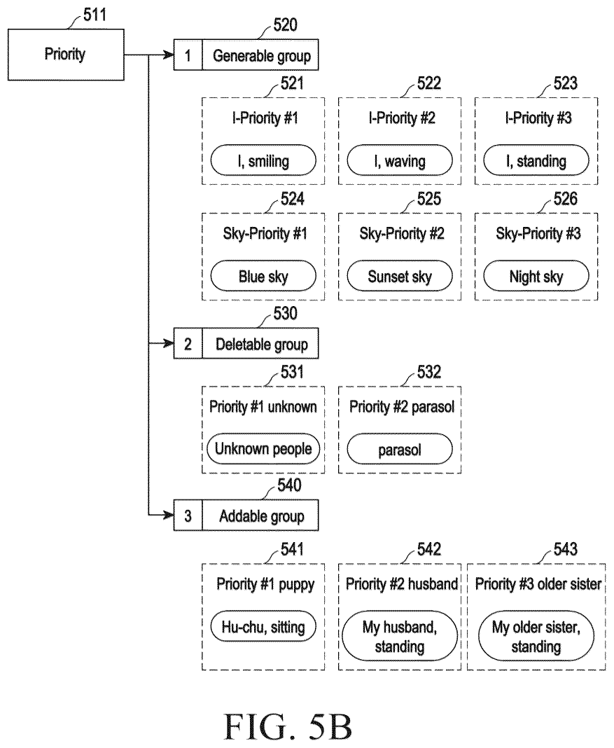

FIG. 5A is a drawing for describing an operating method of an electronic device according to an embodiment.

An embodiment in FIG. 5A will be described with reference to FIG. 5B.

FIG. 5B is a diagram for describing candidate selection according to an embodiment.

According to an embodiment, the electronic device 101 may provide an image and associated texts in operation 501. A method of providing texts for describing one or more objects included in the image has been described above, so a description thereof will not be repeated herein. The electronic device 101 may identify a selection of a first portion among the texts in operation 503. There is no limitation on a method of selecting the first portion. Based on the selection of the first portion, the electronic device 101 may provide one or more candidate texts for the first portion in operation 505. For example, the electronic device 101 may assign a priority 511 to one or more objects included in the image and/or to an addable object as illustrated in FIG. 5B. For example, the electronic device 101 may identify a plurality of candidates for a generable group 520. For example, the electronic device 101 may identify candidate texts 521, 522, and 523 for a text “I, frowning.” For example, the highest priority may be given to a candidate text 521 of “I, smiling,” the next priority may be given to a candidate text 522 of “I, waving,” and the next priority may be given to a candidate text 523 of “I, standing.” For example, if “I, frowning” is selected among the texts for the image, the electronic device 101 may provide at least some of the candidate texts 521, 522, and 523, thereby enabling selection of a user.

For example, the electronic device 101 may identify applicable modification operations for a person based on “I, frowning” corresponding to the person. The applicable modification operations may be, for example, preset. For example, an artificial intelligence model executed by (or accessible by) the electronic device 101 may support providable modification operations, and the electronic device 101 may identify the supported modification operations. The electronic device 101 may provide a text for at least some of pre-specified supported modification operations as a candidate text.

For example, the electronic device 101 may inquire about a modifiable task and identify the candidate text as a response to the inquiry. For example, the candidate text may be provided based on a question-and-answer interaction based on a chat-based scheme. For example, the electronic device 101 may inquire about modifiable tasks for at least some of the texts describing the image to an artificial intelligence model (for example, it may be, but is not limited to, a generative artificial intelligence model based on the chat-based scheme). The artificial intelligence model may provide texts for a modifiable task which may be supported as an answer, and the electronic device 101 may provide texts for the identified modifiable task based on the answer as a candidate text. Meanwhile, those skilled in the art will understand that the above-described scheme of identifying the candidate texts is exemplary and there is no limitation thereto.

For example, the candidate texts 521, 522, and 523 may be arranged in an order of priority, but there is no limitation thereto. For example, if only some of the candidate texts 521, 522, and 523 are provided, a candidate text of a provided target may be provided according to the priority. For example, the priority may be set to be customized for the user based on a history of usage. For example, based on a fact that a history of change to “I, smiling” is identified to be relatively numerous, a relatively high priority may be given to the candidate text 521 of “I, smiling.” For example, the priority may be set based on evaluation of modification (or a performance of the artificial intelligence model). For example, in a case of changing “I, frowning” to “I, smiling,” an expected evaluation score for the modification may be relatively high because an object in a face is not related to another object as the object is modified. For example, if an object corresponding to “I” within the image is sitting, in order to change it to “I, standing,” not only a change in an appearance of the object corresponding to “I” but also boundary processing with another surrounding object and/or modification of the other object are required, and therefore the expected evaluation score may be relatively low. The electronic device 101 may also give a relatively high priority if the expected evaluation score is relatively high. Meanwhile, those skilled in the art will understand that the above-described priority determination scheme is exemplary and there is no limitation thereto. Meanwhile, those skilled in the art will understand that provision of candidate text based on a priority is merely exemplary and that the candidate text may be provided without being based on the priority.

Referring to FIG. 5B, the electronic device 101 may identify and/or provide candidate texts 524, 525, and 526 for “cloudy sky,” which is another object of the generable group 520. Setting priorities for the candidate texts 524, 525, and 526 has been described above, so a description thereof will not be repeated here. The electronic device 101 may identify and/or provide candidate texts 531, and 532 for a deletable group 530. The electronic device 101 may identify and/or provide candidate texts 541, 542, and 543 for an addable group 540. As described above, a candidate text related to generation, deletion, and/or addition may be provided based on pre-specified information, and/or may be identified based on a question-and-answer with artificial intelligence, but there is no limitation on an identifying scheme.

Referring back to FIG. 5A, the electronic device 101 may, in operation 507, identify a selection of the one or more candidate texts. The electronic device 101 may, in operation 509, provide texts including the selected candidate text and an image. The image may be, for example, an image modified based on the selected candidate text. For example, based on a fact that the candidate text 521 is selected among the candidate texts 521, 522, and 523 provided for the text of “I, frowning,” an image in which a frowning face of the object corresponding to “I” is modified to a smiling face may be provided. For example, based on the selection of the candidate text 531, the electronic device 101 may provide a modified image in which persons who failed to be recognized are deleted. For example, based on the selection of candidate text 541, the electronic device 101 may provide an image in which a puppy is added.

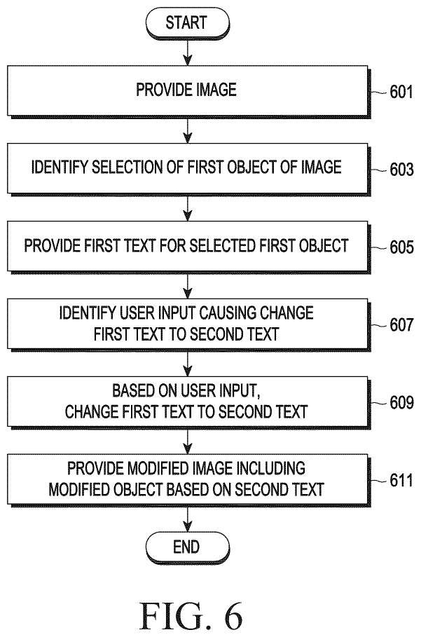

FIG. 6 is a flowchart illustrating an operating method of an electronic device according to an embodiment.

According to an embodiment, an electronic device 101 may provide an image in operation 601. The electronic device 101 may identify a selection of a first object of the image in operation 603. For example, the electronic device 101 may identify a selection of a first object among the image based on a touch (it may be, but is not limited to, another type of gesture) of a user, but there is no limitation on a selecting scheme therefor.

The electronic device 101 may, in operation 605, provide a first text for the selected first object. For example, based on identification of a user touch on the first object corresponding to “I, frowning” in the image, the electronic device 101 may provide “I, frowning” as the first text for describing the first object.

The electronic device 101 may, in operation 607, identify a user input for causing a change of the first text to a second text. In an example, the electronic device 101 may identify the change to the second text based on an input corresponding to the second text (for example, it may be, but is not limited to, an input via an SIP or an input based on user voice). In an example, the electronic device 101 may provide a plurality of candidate texts and may identify that any one of the plurality of candidate texts is selected as the second text.

The electronic device 101 may, in operation 609, change the first text to the second text based on the user input.

The electronic device 101 may, in operation 611, provide a modified image including a modified object based on the second text. In this case, those skilled in the art will understand that expression of the second text may be omitted.

As described above, the electronic device 101 may be configured to modify an image based on provision of a text for a specific object selected by a user and a text change command corresponding thereto. For example, if an object whose image may not be modified is selected, the electronic device 101 may refrain from providing a text or provide a text indicating that modification is not possible.

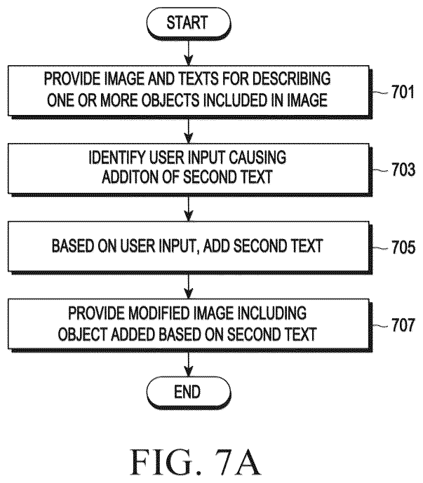

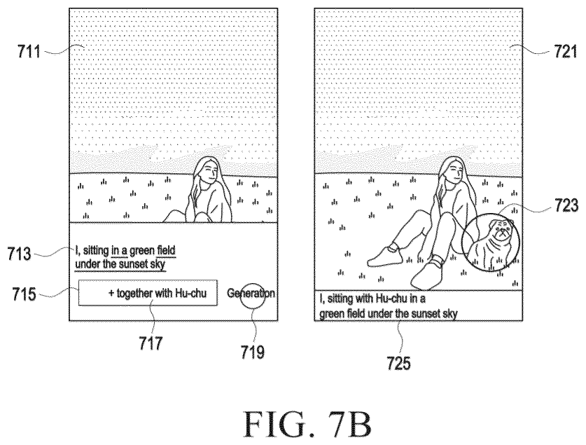

FIG. 7A is a flowchart illustrating an operating method of an electronic device according to an embodiment. An embodiment in FIG. 7A will be explained with reference to FIG. 7B.

FIG. 7B is a drawing for describing object addition according to an embodiment.

According to an embodiment, an electronic device 101 may, in operation 701, provide an image 711 and texts 713 for describing one or more objects included in the image 711, as shown in FIG. 7B.

The electronic device 101 may, in operation 703, identify a user input for causing addition of a second text. For example, as shown in FIG. 7B, the electronic device 101 may provide an object 715 for the addition of the second text. The object 715 may include a text 717 for an addable object. The electronic device 101 may identify an object 719 for causing modification of an image. The object 715 may be an input field that allows the user to enter text (e.g., text 717 reading “together with Hu-chu”), or may be a suggestion box that displays one or more suggested text options for user selection. The object 719 may represent a button or icon that triggers an image generation function when selected or clicked by the user.

For example, the electronic device 101 may identify selection of an object 719 while the text 717 is expressed within the object 715 as a user input, and add a second text in operation 705. Accordingly, the electronic device 101 may provide texts 725 including the existing texts 713 and the added second text. Those skilled in the art will understand that, depending on the implementation, expression of the texts 725 may be omitted.

The electronic device 101 may, in operation 707, provide a modified image 721 including an object 723 added based on the second text.

For example, the addable object may be set based on a recognition target identified based on an analysis result of a plurality of images stored in association with the electronic device 101 or a user account. For example, the addable object may be a pet dog recognized based on the analysis result of the plurality of images. The electronic device 101 may express that the pet dog may be added, for example, together with a recognition result (e.g., the name “Hu-chu”), and may add a corresponding object based on identification of a user command for adding this. Meanwhile, it is merely exemplary that an object of an additional target is determined according to an analysis result of previously obtained images. Those skilled in the art will understand that the electronic device 101 may express an object other than an object identified based on a previously obtained image as the addable object. For example, those skilled in the art will understand that the electronic device 101 may express an object associated with a corresponding scene as the addable object, based on a scene analysis result of the image, and there is no limitation on a type, number, and/or identifying scheme of the addable object.

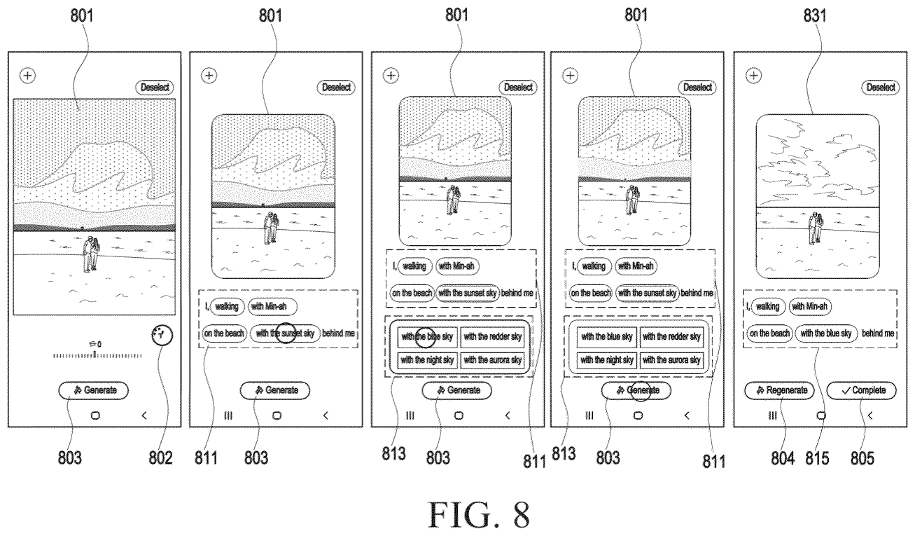

FIG. 8 is a drawing for describing image modification by an electronic device according to an embodiment.

According to an embodiment, an electronic device 101 may provide an image 801. For example, the electronic device 101 may provide the image 801 based on executing a gallery application, or may provide the image 801 captured via a camera application, but there is no limitation on a providing event thereof. The electronic device 101 may provide an object 802 which causes provision of a text to describe the image 801. The electronic device 101 may provide an object 803 which causes generation of a modified image. The object 803 may represent a button or icon that triggers an image generation function when selected or clicked by the user.

Based on identification of selection of the object 802, the electronic device 101 may provide texts 811 for describing the image 801. The texts 811 may include, but are not limited to, texts associated with objects included in the image 801, such as “I,” “walking,” “with Min-ah,” “on the beach,” “with the sunset sky,” and “behind me.” An identifying scheme and/or providing scheme for a text has been described above, so a description thereof will not be repeated herein. For example, the electronic device 101 may identify selection of a text “with the sunset sky.”

Based on selection of a text of “with the sunset sky,” the electronic device 101 may provide candidate texts 813 for “with the sunset sky” as described above. The candidate texts 813 may include, but are not limited to, “with the blue sky,” “with the redder sky,” “with the night sky,” and “with the aurora sky” to describe a modification operation which may replace “with the sunset sky.” An identifying scheme of a candidate text has been described above, so a description will not be repeated here. For example, the electronic device 101 may identify selection of a candidate text of “with the blue sky.” Thereafter, the electronic device 101 may identify selection of the object 803 which causes generation of the modified image.

The electronic device 101 may provide the texts 813 including the candidate text of “with the blue sky.” The electronic device 101 may, for example, modify (or update) at least some of the existing texts 811 based on the selected candidate text. The electronic device 101 may provide a modified image 831 based on the selected candidate text. For example, the modified image 831 may be generated by changing an object corresponding to the selected text to an object corresponding to the candidate text. For example, the modified image 831 may be generated by changing at least some of a shape and/or an attribute of a surrounding object based on an influence of the object corresponding to the selected text on the surrounding object. As described above, the change from “with the sunset sky” to “with the blue sky” leads to an observable increase in the amount of light in the environment, which may be quantified as an enhancement in the luminance of the surrounding scene. This change may affect various objects within the scene, such as a person, the ground, or other environmental elements. The electronic device 101 may use image processing algorithms to generate the modified image 831 by applying an effect corresponding to the increase in ambient light levels (e.g., the light amount to the surrounding object such as a person, the ground, etc.). The term “effect” may refer to specific visual adjustments or image-processing algorithms the electronic device 101 applies to render the modified image 831 as if it were captured under the new light conditions (i.e., the transition from the sunset sky to the blue sky). These “effects” may include brightness adjustments, tone mapping, saturation or color enhancement, exposure correction, shading or shadow effects, and similar modifications. For example, brightness of the surrounding object may increase according to the increase in the light amount, but this is exemplary and there is no limitation on a type of an influence and/or an applying scheme.

The electronic device 101 may provide an object 804 which causes regeneration of a modified image. The object 804 may represent a button or icon that triggers an image regeneration function when selected or clicked by the user. When identifying selection of another text and/or another candidate text and then identifying selection of the object 804, the electronic device 101 may provide a modified image based on the newly selected text and/or candidate text. The electronic device 101 may provide an object 805 which causes completion of modification. Based on selection of the object 805 and/or selection of an object which causes additional storage, the modified image may be stored within the electronic device 101 or in a data storage (for example, it may be, but is not limited to, a cloud storage) which is accessible based on the user account. Meanwhile, an object 833 may be expressed to indicate an object to which modification is applied, but there is no limitation thereto.

According to an embodiment, the electronic device 101 may express a unmodifiable text and a modifiable text to be visually distinguished. For example, “walking,” “with Min-ah,” “on the beach,” and “with the sunset sky” among the texts 811 are modifiable texts, and the electronic device 101 may further express a circular object around the texts. For example, “I,” and “behind me” among the texts 811 are unmodifiable texts, and the electronic device 101 may not express a circular object around the texts.

Meanwhile, those skilled in the art will understand that expression of a circular object around a text is merely exemplary, and that there is no limitation on a scheme of distinguishing between a modifiable text and a unmodifiable text. For example, if there is no artificial intelligence model for changing an object corresponding to “behind me,” and/or the artificial intelligence model does not support the change of the corresponding object, the electronic device 101 may identify that “behind me” is the unmodifiable text. For example, if a text is a designated text and/or a designated part of speech, the electronic device 101 may identify that the corresponding text is the unmodifiable text. For example, “I” may be designated as the unmodifiable text, so the electronic device 101 may identify that “I” is the unmodifiable text. Meanwhile, a scheme of determining whether a text is a unmodifiable text as described above is exemplary, and that there is no limitation on the scheme.

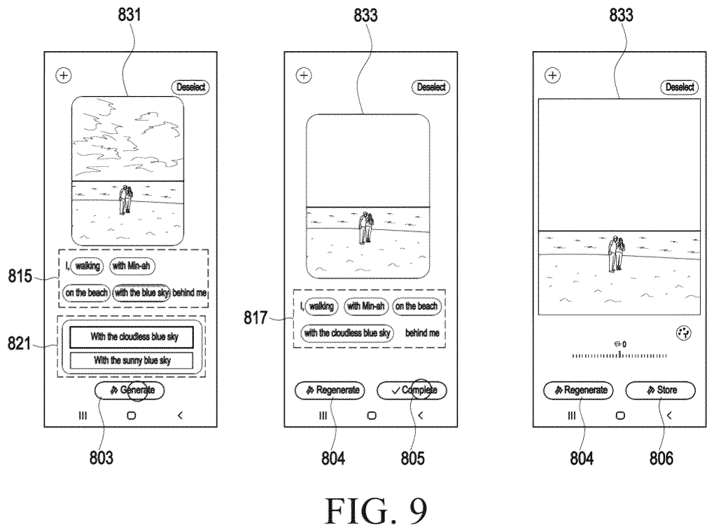

FIG. 9 is a drawing for describing image modification by an electronic device according to an embodiment.

According to an embodiment, an electronic device 101 may provide a modified image 831 generated based on a text of “with the sunset sky” being changed to “with the blue sky”, for example, as described with reference to FIG. 8. The electronic device 101 may provide texts 815 corresponding to the modified image 831. The texts 815 may include texts e.g., “I,” “am walking,” “with Min-ah,” “on the beach,” and “behind me”) before modification and a modified text (e.g., “with the blue sky”). The electronic device 101 may identify selection of the modified text (e.g., “with the blue sky”), for example.

The electronic device 101 may provide candidate texts 821 which may replace “with the blue sky” based on identification of selection of the text of “with the blue sky.” For example, the candidate texts 821 may include “with the cloudless blue sky” and “with sunny blue sky,” but there is no limitation on a type and/or number thereof. For example, the electronic device 101 may provide “with the cloudless blue sky” and “with the sunny blue sky” as candidate texts 821 associated with “with the blue sky” based on identifying that a change from “with the sunset sky” to “with the blue sky” is performed. For example, “with the cloudless blue sky” among the candidate texts 821 may include the modified text “with the blue sky,” but this is exemplary and there is no limitation thereto. For example, the electronic device 101 may provide “with the cloudless blue sky” and “with the sunny blue sky” as the candidate texts 821 related to “with blue sky” by giving a relatively high priority to a candidate text including “with the blue sky” among replaceable candidate texts, but there is no limitation on a providing scheme therefor. Meanwhile, this is exemplary, and the electronic device 101 may also be set to provide candidate texts unrelated to “with the blue sky” according to selection of “blue sky.”

For example, the electronic device 101 may identify selection of a candidate text of “with the cloudless blue sky.” Based on the selection of the candidate text of “with the cloudless blue sky,” the electronic device 101 may change an existing text of “with the blue sky” to the candidate text of “with the cloudless blue sky.” Accordingly, texts 817 for describing an image including “with the cloudless blue sky” may be provided. The electronic device 101 may identify selection of the text of “with the cloudless blue sky.” The electronic device 101 may identify selection of an object 803 after the selection of the text of “with the cloudless blue sky.” Based on the identification of the selection of the object 803, the electronic device 101 may provide a modified image 833 in which an object corresponding to “with the cloudless blue sky” is reflected. The electronic device 101 may express an object (e.g., an object corresponding to the sky from which an object such as a cloud is deleted) to represent a changed object on the modified image 833, and there is no limitation thereto. The electronic device 101 may provide the texts 817 for describing the image 833 including the changed text (e.g., “with the cloudless blue sky”). For example, based on identification of selection of an object 805 which causes storage, the electronic device 101 may provide an object 806 which causes storage. Based on identification of selection of the object 806, the modified image 833 may be stored in the electronic device 101 and/or a storage accessible based on a user account.

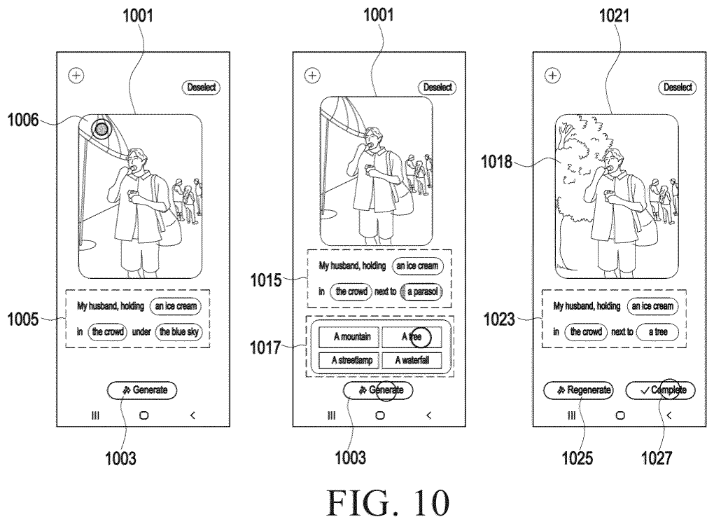

FIG. 10 is a drawing for describing image modification by an electronic device according to an embodiment.

According to an embodiment, an electronic device 101 may provide an image 1001. The electronic device 101 may provide texts 1005 for describing the image 1001. The texts 1005 may include, for example, “My husband,” “holding,” “an ice cream,” “in,” “the crowd,” “under,” and “the blue sky.” As described above, the texts 1005 may be provided based on a recognition result for the image 1001. If a plurality of objects are included in the image 1001, as described above, for example, only texts for some of objects may be provided, and texts for the remaining objects may not be provided. However, a user may identify modification of objects other than the provided texts 1005.

The electronic device 101 may identify a touch 1007 (or other gestures such as a long press, a flick, a double-click etc.) on an object 1006 within the image 1001 as a user input, which initiates or triggers a text change function. The user input may trigger the activation of editable mode for the texts 1005. The electronic device 101 may provide a text (e.g., “next to a parasol”) for an object corresponding to the user input based on identification of the user input which causes the text change. For example, the image 1001 may initially be displayed without the texts 1005. When the user input (e.g., the touch 1007) activates a text-editable mode, the texts 1005 are shown alongside the image 1001. The electronic device 101 may display the texts 1005 such that editable texts (e.g., “an ice cream,” “the crowd,” and “the blue sky”) are visually distinct from non-editable texts (e.g., “My husband, holding,” “in,” and “under”) within the texts 1005. In an embodiment in FIG. 10, the electronic device 101 is illustrated as replacing an existing text “under the blue sky” with the text (e.g., “next to a parasol”) for the object corresponding to the user input, but this is exemplary.

Those skilled in the art will understand that the electronic device 101 may be implemented to add the text (e.g., “next to a parasol”) for the object corresponding to the user input while maintaining the existing text. For example, the electronic device 101 may replace “under the blue sky” identified as meaning of “place” with “next to a parasol” specified by the user, but this is exemplary. The electronic device 101 may provide texts 1015 for describing the image 1001 including “next to a parasol” as described above. The electronic device 101 may identify selection of a text of “a parasol,” for example. Based on the identification of the selection of the text of “a parasol,” the electronic device 101 may provide candidate texts 1017. For example, the electronic device 101 may identify selection of a candidate text of “a tree” among the candidate texts 1017. After identifying the selection of the candidate text of “a tree”, the electronic device 101 may identify selection of an object 1003 which causes generation of a modified image. Based on the identification of the selection of the object 1003, the electronic device 101 may provide a modified image 1021 by changing an object 1006 corresponding to the text of “a parasol” to an object 1018 corresponding to the candidate text of “a tree.” The electronic device 101 may provide texts 1023 for describing the modified image 1021. The texts 1023 may include “a tree” selected as the candidate text. The electronic device 101 may also provide an object 1025 which causes regeneration and/or an object 1027 which causes completion of modification, and there is no limitation thereto.

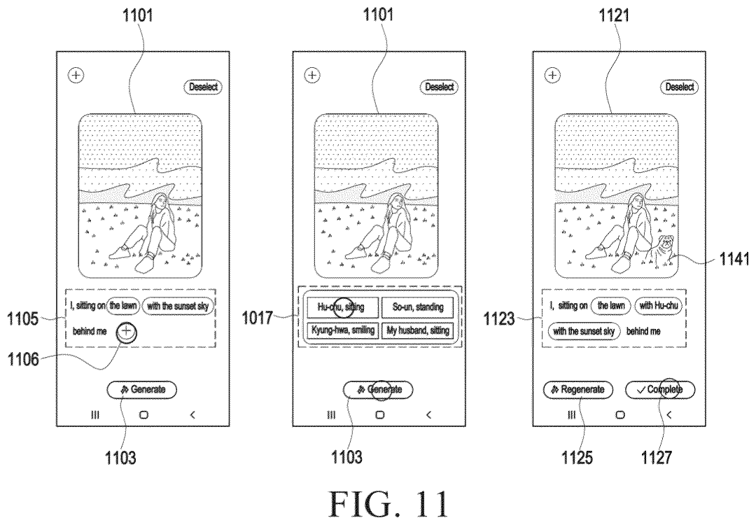

FIG. 11 is a drawing for describing image modification by an electronic device according to an embodiment.

According to an embodiment, an electronic device 101 may provide an image 1101. The electronic device 101 may provide texts 1105 for describing the image 1101. The texts 1105 may include, for example, “I, sitting,” “on the lawn,” “with the sunset sky,” and “behind me” to describe objects included in the image 1101. The electronic device 101 may provide an object 1103 which causes generation of a modified image. The electronic device 101 may provide an object 1106 which causes addition of an object and/or a text, for example. The object 1106 may represent a button or icon (e.g., a plus symbol) that enables the addition of a new text within the texts 1105. Based on identification of selection of the object 1106, the electronic device 101 may provide candidate texts 1107 for objects which may be added to the image 1101. For example, the electronic device 101 may provide the objects which may be added to the image 1101 based on a recognition result in images stored in the electronic device 101 and/or a storage accessible based on a user account, but there is no limitation thereto. The electronic device 101 may provide a candidate text based on the recognition result.

The electronic device 101 may provide a candidate text based on at least some of recognition results, for example, based on scene analysis of the image 1101. For example, the electronic device 101 may identify, as at least some of the scene analysis, that a recognition result of a person in the image 1101 is “I.” The electronic device 101 may provide a priority for each of the recognition results based on the number of times each of the recognition results is recognized together with “I,” based on an analysis result of stored images. For example, “Hu-chu,” “So-un,” “Kyung-hwa,” and “my husband” may be used to compose candidate texts based on a fact that the number of times that a pet dog recognized as “Hu-chu,” a person recognized as “So-un,” a person recognized as “Kyung-hwa,” and a person recognized as “my husband” are recognized together with “I” is greater than the number of times that they corresponded to other recognition results. Meanwhile, priority setting based on the number of times images are recognized together is simply exemplary, and there is no limitation on a scheme of determining a priority. For example, the electronic device 101 may also set a priority based on the date on which an image is photographed.

The electronic device 101 may identify “sitting,” “standing,” “smiling,” and “sitting” which are modifiers for “Hu-chu,” “So-un,” “Kyung-hwa,” and “my husband,” based on scene analysis of a pre-stored image. For example, the pre-stored image may include “Hu-chu, sitting.” The electronic device 101 may recognize “Hu-chu, sitting” from the pre-stored image. The pre-stored image may be, for example, an image in which “I” is recognized, but is not limited thereto. For example, the electronic device 101 may identify a modifier of “standing” corresponding to “So-un,” identify a modifier of “smiling” corresponding to “Kyung-hwa,” and/or identify a modifier of “sitting” corresponding to “my husband,” based on scene analysis of the pre-stored image. In this case, a modifier associated with a candidate text and/or an object generated based on the candidate text may rely on the pre-stored image.

The electronic device 101 may identify the modifiers “sitting,” “standing,” “smiling,” and “sitting” for “Hu-chu,” “So-un,” “Kyung-hwa,” and “my husband” based on scene analysis of the image 1101 to be modified. For example, the electronic device 101 may identify a position, a size, and/or a posture of a person within the image 1101. For example, the electronic device 101 may identify that the person in the image 1101 takes a sitting posture. Based on the posture of the person in the image 1101 being sitting, the electronic device 101 may set the modifier for “Hu-chu” to “sitting.” In this case, the modifier associated with the candidate text and/or the object generated based on the candidate text may not rely on the pre-stored image, but may rely on the image 1101 to be modified.

The electronic device 101 may identify selection of “Hu-chu, sitting” among the candidate texts 1017. Based on the identification of the selection of “Hu-chu, sitting,” the electronic device 101 may provide a modified image 1121 to which an object 1141 corresponding to “Hu-chu, sitting” is added. The object 1141 corresponding to “Hu-chu, sitting” may be obtained and/or generated based on, for example, the pre-stored image, but is not limited thereto.

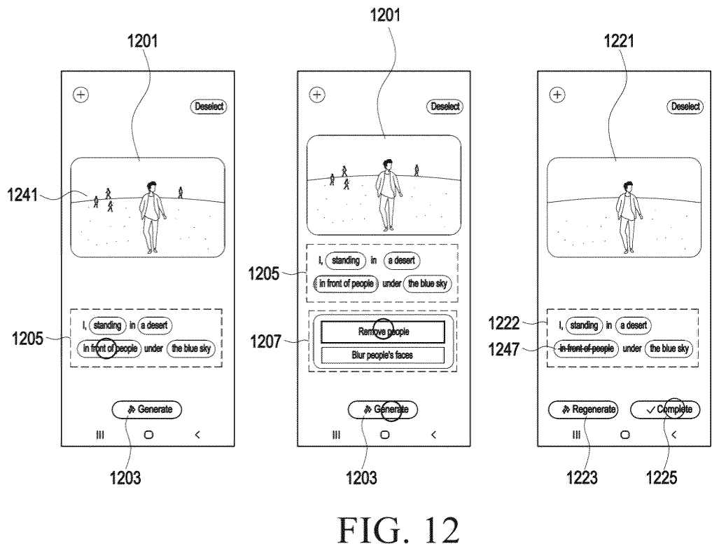

FIG. 12 is a drawing for describing image modification by an electronic device according to an embodiment.

According to an embodiment, an electronic device 101 may provide an image 1201. The electronic device 101 may provide texts 1205 for describing the image 1201. The texts 1205 may include, for example, “I,” “standing,” “in,” “a desert,” “in front of people,” “under,” and “the blue sky” for describing objects included in the image 1201. For example, “in front of people” may be a text corresponding to a plurality of persons included in the image 1201, but is not limited thereto. The electronic device 101 may provide an object 1203 which causes modification of an image. The electronic device 101 may identify selection of the text of “in front of people.”

The electronic device 101 may provide a plurality of candidate texts 1207 corresponding to the selection of the text of “in front of people.” The plurality of candidate texts 1207 may include “remove people” and “blur people's faces.” Candidate texts in the present embodiment may include a text for deleting and/or processing an object for the selected text, other than a text which replaces the text of “in front of people.” For example, based on a fact that an object 1241 corresponding to “in front of people” is smaller than or equal to a size of an object included in a background or a designated size, the electronic device 101 may provide processing related to the background, for example, deleting and/or blurring, but there is no limitation thereto. For example, based on a fact that the object 1241 corresponding to “in front of people” is identified in a process of recognizing the background, the electronic device 101 may identify that the object 1241 corresponding to “in front of people” is included in the background, but there is no limitation on an identifying scheme therefor.

In the present embodiment, the electronic device 101 has been described as providing a candidate text for deletion and/or processing of an object corresponding to a selected text based on identification of the selection of the text, but this is exemplary. The electronic device 101 may also be configured to provide the candidate text for deletion and/or processing of the object based on identification of additional user input for deletion and/or processing after a specific text is selected.

The electronic device 101 may identify selection of a candidate text of “remove people” among the candidate texts 1207. The electronic device 101 may identify selection of an object 1203 after the selection of the candidate text of “remove people.” The electronic device 101 may perform object deletion as modification corresponding to the candidate text based on the identification of the selection of the candidate text and/or the object 1203. The electronic device 101 may provide a modified image 1221 generated by deleting an object 1241 included in the existing image 1201. The electronic device 101 may perform inpainting for deleting the object 1241 included in the image 1201 and drawing the deleted portion to correspond to a surrounding background, and for example, a GAN, a CNN, DeepFill, EdgeConnect, and/or the like may be used, but there is no limitation thereto.

The electronic device 101 may provide texts 1222 for describing the image 1221. For example, a text 1227 corresponding to a deleted object may be indicated using a strikethrough line (also referred to as a “deletion line” or “deletion indicator”). However, it should be understood that this is merely one possible representation, and alternative methods of indicating a deleted object may be used, or no specific indication may be provided at all. The electronic device 101 may also provide an object 1223 for regeneration and/or an object 1225 for causing completion.

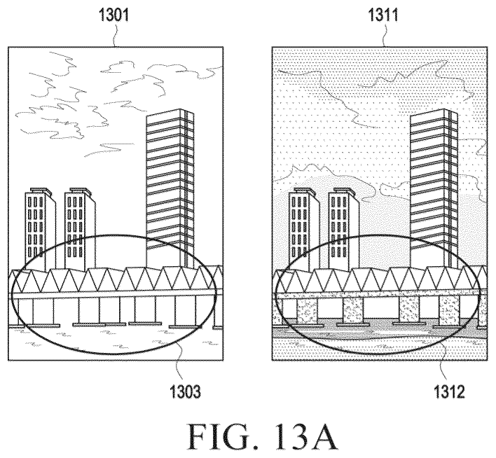

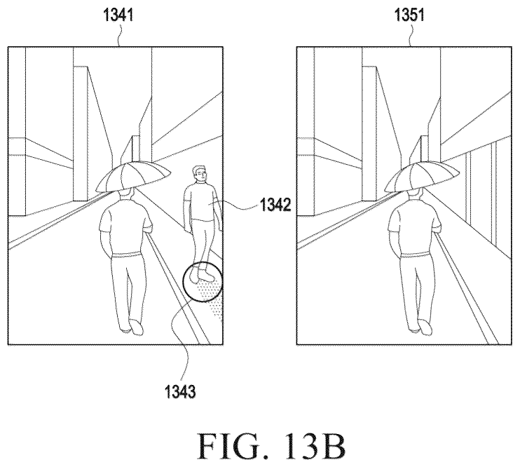

FIG. 13A is a diagram for describing image modification by an electronic device according to an embodiment.

According to an embodiment, an electronic device 101 may perform modification on an image 1301. As described above, the electronic device 101 may provide texts for describing the image 1301. For example, the electronic device 101 may provide texts of “buildings,” “located at the riverside,” and “under a blue sky” as texts for describing the image 1301. The electronic device 101 may identify a user input which causes the text of “under the blue sky” to be changed to “under the sunset sky,” for example. Based on the user input, the electronic device 101 may provide a modified image 1311. The modified image 1311 may include, for example, an object 1311, i.e., the sunset sky, corresponding to the changed text of “under the sunset sky.”

Meanwhile, as described above, the electronic device 101 may apply an effect indicating an influence based on a change to the corresponding object 1311 along with a change in the object 1311. For example, a color of an object 1303 corresponding to “the riverside” within the image 1301 before modification may be different from a color of an object 1312 corresponding to “the riverside” within the modified image 1311. For example, an effect corresponding to an influence due to a change in a specific object may be applied based on CycleGAN, Pix2Pix, neural style transfer (NST), etc., but there is no limitation thereto.

FIG. 13B is a drawing for describing image modification by an electronic device according to an embodiment.

According to an embodiment, an electronic device 101 may perform modification on an image 1341. As described above, the electronic device 101 may provide texts for describing the image 1341. For example, the electronic device 101 may provide texts of “I,” “walking down the street,” “with people,” and “under the blue sky” as the texts for describing the image 1341. The electronic device 101 may identify a user input for removing an object 1342 corresponding to a text of “with people,” for example. Based on the user input, the electronic device 101 may provide a modified image 1351. The modified image 1351 may be generated by deleting the object 1342 corresponding to “with people,” for example, which is selected as a deletion target.

Meanwhile, the electronic device 101 may delete an object 1343, i.e., a shadow, associated with the object 1342 corresponding to “with people.” For example, the electronic device 101 may be configured to delete the object 1343 according to the deletion of the object 1342 based on a relationship between the object 1343 and the object 1342. To this end, inpainting may be performed, and for example, a GAN, a CNN, DeepFill, EdgeConnect, and/or the like may be used, but there is no limitation thereto. As described with reference to FIGS. 13A and 13B, a modified image may be generated by applying not only a change in an object designated by a text, but also an effect indicating an influence by the corresponding change.

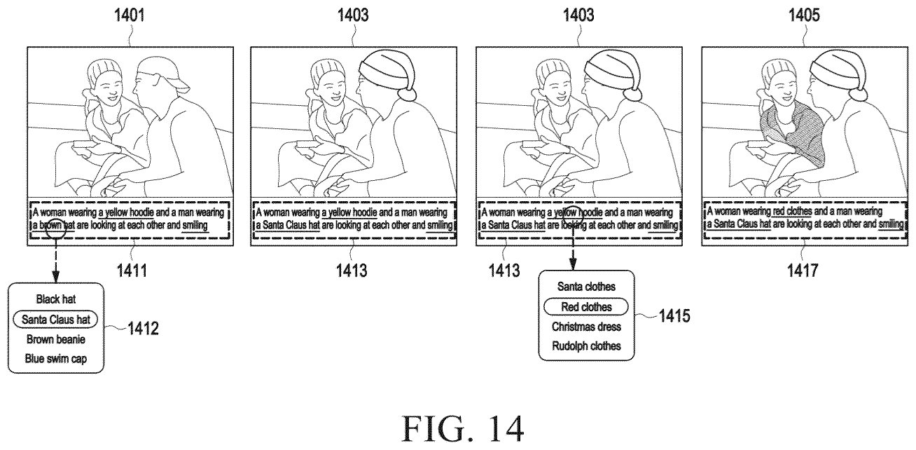

FIG. 14 is a drawing for describing image modification by an electronic device according to an embodiment.

According to an embodiment, an electronic device 101 may provide an image 1401. The electronic device 101 may provide texts 1411 for describing the image 1401. The texts 1411 may include, for example, “a woman,” “wearing,” “a yellow hoodie and,” “a man,” “wearing,” “a brown hat,” “are looking at,” “each other and,” “smiling” for describing objects included in the image 1401. The electronic device 101 may identify a selection of, for example, “a brown hat.” The electronic device 101 may provide candidate texts 1412 corresponding to the selection of “a brown hat.” The candidate texts 1412 may include, for example, “a black hat,” “a Santa Claus hat,” “a brown beanie,” and “a blue swim cap.” The electronic device 101 may, for example, identify a selection of a candidate text of “a Santa Claus hat.” Based on identifying the selection of the candidate text of “a Santa Claus hat,” the electronic device 101 may provide a modified image 1403 including an object corresponding to the candidate text of “a Santa Claus hat.” The electronic device 101 may provide texts 1413 for describing the modified image 1403. The texts 1413 for describing the modified image 1403 may include “a woman,” “wearing,” “a yellow hoodie and,” “a man,” “wearing,” “a Santa Claus hat,” “are looking at,” “each other and,” “smiling.”

The electronic device 101 may then additionally identify selection of the text of “a yellow hoodie and.” The electronic device 101 may provide candidate texts 1415 based on the identification of the selection of the text of “a yellow hoodie and.” The electronic device 101 may also provide the candidate texts 1415 based on previously modified information based on image modification associated with “a Santa Claus hat” being performed. For example, the electronic device 101 may provide, as the candidate texts 1415, “Santa clothes,” “red clothes,”

“Christmas dress,” and “Rudolph clothes” which are semantically associated with “a Santa Claus hat.” For example, the candidate texts 1415 such as “Santa clothes,” “red clothes,” “Christmas dress,” and “Rudolph clothes” may be identified based on both the modified text “a Santa Claus hat” and the selected text “a yellow hoodie and,” but there is no limitation thereto. If no modification associated with “a Santa Claus hat” is performed, the electronic device 101 may provide candidate texts unrelated to “Santa clothes,” “red clothes,” “Christmas dress,” and “Rudolph clothes.” For example, the candidate text of “red clothes” among the candidate texts 1415 may be selected. Based on identification of the selection of the candidate text of “red clothes,” the electronic device 101 may provide a modified image 1405 including an object corresponding to the candidate text of “red clothes.” The electronic device 101 may provide texts 1417 for describing the modified image 1405. The texts 1417 may include “a woman,” “wearing,” “red clothes and,” “a man,” “wearing,” “a Santa Claus hat,” “are looking at,” “each other and,” “smiling.”

As described above, the electronic device 101 may also set candidate texts for another text based on previously modified information related to a specific text.

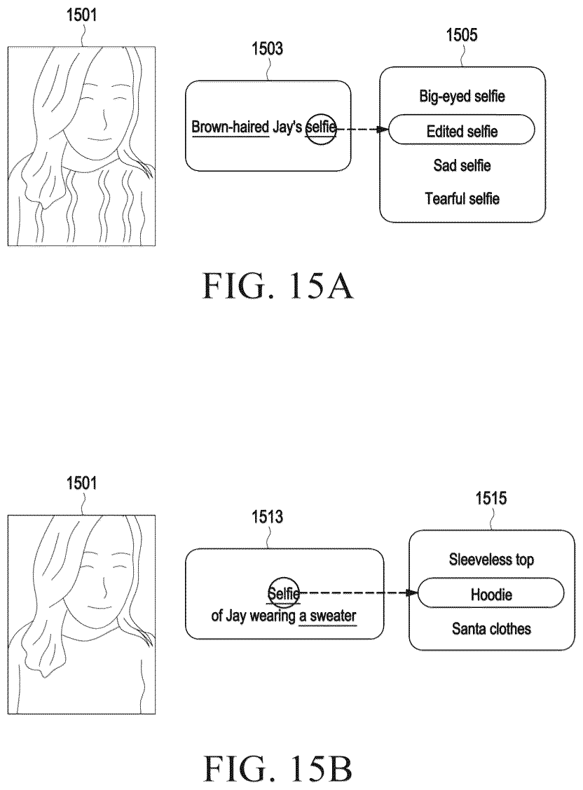

FIG. 15A is a diagram for describing image modification by an electronic device according to various embodiments.

FIG. 15B is a diagram for describing image modification by an electronic device according to various embodiments.

According to an embodiment, referring to FIG. 15A, an electronic device 101 may provide an image 1501. The electronic device 101 may provide texts 1503 for describing the image 1501. The texts 1503 may include, for example, “brown-haired,” “Jay's,” “selfie.” The electronic device 101 may identify selection of, for example, “selfie.” Based on the identification of the selection of “selfie,” the electronic device 101 may provide candidate texts 1505.

The texts 1503 and/or the candidate texts 1505 may be set based on, for example, a modification history by a user. For example, based on a modification history by the user related to “face,” the texts 1503 may include “brown-haired,” “Jay's,” “selfie,” and/or the candidate texts 1505 may include “big-eyed selfie,” “sad selfie,” and “tearful selfie.” For example, “big-eyed selfie,” “sad selfie,” and “tearful selfie” may be set based on modifications previously performed by the user, but are not limited thereto. For example, the candidate texts 1505 may include “edited selfie.” For example, if “edited selfie” is selected, the electronic device 101 may perform a modification saved by the user (for example, it may be a modification which relatively brightens a skin color of a face portion, but there is no limitation thereto). For example, the user may manually perform a modification on an image and save this as a modification set by the user.

The electronic device 101 may store information (e.g., a degree of adjustment of brightness value for the face portion) related to the modification as the modification set by the user. The electronic device 101 may perform an image modification (e.g., a modification based on the degree of adjustment of brightness value for the face portion) based on stored information, based on a selection of candidate text corresponding to the modification set by the user, such as “edited selfie.”

According to an embodiment, referring to FIG. 15B, the electronic device 101 may provide the image 1501. The electronic device 101 may provide texts 1513 for describing the image 1501. The texts 1513 may include, for example, “selfie,” “of Jay,” “wearing,” and “a sweater.”

As described above, the electronic device 101 may set the texts 1513 and/or candidate texts 1515 based on a history of modifications for the user. For example, the electronic device 101 may provide the texts 1513 different from the texts 1503 in FIG. 15A based on a history of modifications the user has made related to “clothes.” The electronic device 101 may identify a selection of, for example, “selfie.” Based on the identification of the selection of “selfie,” the electronic device 101 may provide the candidate texts 1515. The candidate texts 1515 may be set based on, for example, the history of modification for the user. For example, based on a history of modifications performed by the user related to “clothes,” the candidate texts 1515 may include “sleeveless top,” “hoodie,” and “Santa clothes.” For example, “sleeveless top,” “hoodie,” and “Santa clothes” may be set based on a modification previously performed by the user, but there is no limitation thereto. The electronic device 101 may modify the image 1501 based on a selected candidate text among the candidate texts 1515.

In one or more embodiments of the present disclosure, an electronic device may include: a display; one or more processors; and memory storing instructions. The instructions, when executed by the one or more processors individually or collectively, may cause the electronic device to: provide an image and texts that describe the image, change a first text, included in the texts, to a second text based on a user input, and provide a modified image in which an object is generated, removed, or modified based on the second text.

The instructions, when executed by the one or more processors individually or collectively, may cause the electronic device to: provide a user interface for inputting the second text, and identify the second text based on the user input inputted via the user interface.

The instructions, when executed by the one or more processors individually or collectively, may cause the electronic device to: identify the user input for designating the second text inputted via a virtual input panel for inputting a plurality of characters.

The instructions, when executed by the one or more processors individually or collectively, may cause the electronic device to: provide at least one candidate text corresponding to the first text, and identify the user input indicating a selection of the second text among the at least one candidate text.

The at least one candidate text may be set based on a priority of each of a plurality of candidate texts corresponding to the first text.

The at least one candidate text may be set based on an image modification history of a user.

The instructions, when executed by the one or more processors individually or collectively, may cause the electronic device to: provide the modified image including, as the modified object, a second object corresponding to the second text by replacing a first object corresponding to the first text.

The instructions, when executed by the one or more processors individually or collectively, may cause the electronic device to: provide the modified image including the modified object by changing a first attribute of the object corresponding to the first text to a second attribute corresponding to the second text.

The instructions, when executed by the one or more processors individually or collectively, may cause the electronic device to: provide the modified image including the modified object by applying a visual effect to a neighbor object of a first object, which corresponds to the first text, based on the second text.

The instructions, when executed by the one or more processors individually or collectively, may cause the electronic device to: identify the user input for causing an addition of a third text to the texts; display a modified version of the texts including the third text based on the user input, and provide the modified image including the generated object that correspond to the third text.

The instructions, when executed by the one or more processors individually or collectively, may cause the electronic device to: identify the user input for causing deletion of a fourth text included in the texts, display a modified version of the texts that excludes the fourth text or includes a deletion indicator applied to the fourth text, based on the user input, and provide the modified image in which the object corresponding to the fourth text is removed.

The instructions, when executed by the one or more processors individually or collectively, may cause the electronic device to: provide at least one candidate text associated with the second text based on identifying a selection of the modified object corresponding to the second text among objects included in the modified image, and provide an additional modified image including an object additionally modified corresponding to a selected candidate text, based on identifying a selection of the candidate text among the at least one candidate text associated with the second text. At least a part of the at least one candidate text associated with the second text includes at least a part of the second text.

The instructions, when executed by the one or more processors individually or collectively, may cause the electronic device to: provide at least one candidate text associated with the second text and a sixth text, based on identifying a selection of an object corresponding to the sixth text different from the second text, and provide an additional modified image including an object additionally modified corresponding to a selected candidate text, based on identifying a selection of the candidate text among the at least one candidate text associated with the second text and the sixth text.

The instructions, when executed by the one or more processors individually or collectively, may cause the electronic device to: display an editable portion of the texts to be visually distinct from an uneditable portion of the texts.

In one or more embodiments of the present disclosure, there is provided a non-transitory computer-readable storage medium storing one or more instructions, when executed by one or more processors of an electronic device individually or collectively, causing the electronic device to perform: providing an image and texts that describe the image; changing a first text, included in the texts, to a second text based on a user input; and providing a modified image, in which an object is generated, removed, or modified based on the second text.

The one or more instructions may cause the electronic device to perform: providing a user interface for inputting the second text; and identifying the second text based on the user input inputted via the user interface.

The one or more instructions may cause the electronic device to perform: providing at least one candidate text corresponding to the first text; and identifying the user input indicating a selection of the second text among the at least one candidate text.

The providing of the modified image may include: providing the modified image including, as the modified object, a second object corresponding to the second text by replacing a first object corresponding to the first text.

The providing of the modified image may include: providing the modified image including the modified object by changing a first attribute of the object corresponding to the first text to a second attribute corresponding to the second text.

In one or more embodiments of the present disclosure, an operating method of an electronic device may include: providing an image and texts that describe the image; changing a first text, included in the texts, to a second text based on a user input; and providing a modified image in which an object is generated, removed, or modified based on the second text.

According to an embodiment of the disclosure, the providing the image and the texts for describing the one or more objects included in the image according to the recognition result for the image may include an operation of expressing a first part which is changeable and a second part which is unchangeable among the texts to be distinguished.

The electronic device according to an embodiment may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that an embodiment of the disclosure and the terms used therein are not intended to limit the technological features set forth herein to a particular embodiment and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with an embodiment of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or two or more functions. For example, according to an embodiment, the module may be implemented in a form of an application-specific integrated circuit (ASIC).

An embodiment as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a display;
one or more processors; and
memory storing instructions;
wherein the instructions, when executed by the one or more processors individually or collectively, cause the electronic device to:
provide an image and texts that describe the image,
change a first text, included in the texts, to a second text based on a user input, and
provide a modified image in which an object is generated, removed, or modified based on the second text.

2. The electronic device of claim 1, wherein the instructions, when executed by the one or more processors individually or collectively, cause the electronic device to:
provide a user interface for inputting the second text, and
identify the second text based on the user input inputted via the user interface.

3. The electronic device of claim 1, wherein the instructions, when executed by the one or more processors individually or collectively, cause the electronic device to:
identify the user input for designating the second text inputted via a virtual input panel for inputting a plurality of characters.

4. The electronic device of claim 1, wherein the instructions, when executed by the one or more processors individually or collectively, cause the electronic device to:
provide at least one candidate text corresponding to the first text, and
identify the user input indicating a selection of the second text among the at least one candidate text.

5. The electronic device of claim 4, wherein the at least one candidate text is set based on a priority of each of a plurality of candidate texts corresponding to the first text.

6. The electronic device of claim 4, wherein the at least one candidate text is set based on an image modification history of a user.

7. The electronic device of claim 1, wherein the instructions, when executed by the one or more processors individually or collectively, cause the electronic device to:
provide the modified image comprising, as the modified object, a second object corresponding to the second text by replacing a first object corresponding to the first text.

8. The electronic device of claim 1, wherein the instructions, when executed by the one or more processors individually or collectively, cause the electronic device to:
provide the modified image comprising the modified object by changing a first attribute of the object corresponding to the first text to a second attribute corresponding to the second text.

9. The electronic device of claim 1, wherein the instructions, when executed by the one or more processors individually or collectively, cause the electronic device to:
provide the modified image comprising the modified object by applying a visual effect to a neighbor object of a first object, which corresponds to the first text, based on the second text.

10. The electronic device of claim 1, wherein the instructions, when executed by the one or more processors individually or collectively, cause the electronic device to:
identify the user input for causing an addition of a third text to the texts;
display a modified version of the texts comprising the third text based on the user input, and
provide the modified image comprising the generated object that correspond to the third text.

11. The electronic device of claim 1, wherein the instructions, when executed by the one or more processors individually or collectively, cause the electronic device to:
identify the user input for causing deletion of a fourth text included in the texts,
display a modified version of the texts that excludes the fourth text or comprises a deletion indicator applied to the fourth text, based on the user input, and
provide the modified image in which the object corresponding to the fourth text is removed.

12. The electronic device of claim 1, wherein the instructions, when executed by the one or more processors individually or collectively, cause the electronic device to:
provide at least one candidate text associated with the second text based on identifying a selection of the modified object corresponding to the second text among objects included in the modified image, and
provide an additional modified image comprising an object additionally modified corresponding to a selected candidate text, based on identifying a selection of the candidate text among the at least one candidate text associated with the second text,
wherein at least a part of the at least one candidate text associated with the second text comprises at least a part of the second text.

13. The electronic device of claim 1, wherein the instructions, when executed by the one or more processors individually or collectively, cause the electronic device to:
provide at least one candidate text associated with the second text and a sixth text, based on identifying a selection of an object corresponding to the sixth text different from the second text, and
provide an additional modified image including an object additionally modified corresponding to a selected candidate text, based on identifying a selection of the candidate text among the at least one candidate text associated with the second text and the sixth text.

14. The electronic device of claim 1, wherein the instructions, when executed by the one or more processors individually or collectively, cause the electronic device to:
display an editable portion of the texts to be visually distinct from an uneditable portion of the texts.

15. A non-transitory computer-readable storage medium storing one or more instructions, when executed by one or more processors of an electronic device individually or collectively, causing the electronic device to perform:
providing an image and texts that describe the image;
changing a first text, included in the texts, to a second text based on a user input; and
providing a modified image, in which an object is generated, removed, or modified based on the second text.

16. The non-transitory computer-readable storage medium of claim 15, wherein the one or more instructions cause the electronic device to perform:
providing a user interface for inputting the second text; and
identifying the second text based on the user input inputted via the user interface.

17. The non-transitory computer-readable storage medium of claim 15, wherein the one or more instructions cause the electronic device to perform:
providing at least one candidate text corresponding to the first text; and
identifying the user input indicating a selection of the second text among the at least one candidate text.

18. The non-transitory computer-readable storage medium of claim 15, wherein the providing of the modified image comprises:
providing the modified image comprising, as the modified object, a second object corresponding to the second text by replacing a first object corresponding to the first text.

19. The non-transitory computer-readable storage medium of claim 15, wherein the providing of the modified image comprises:
providing the modified image comprising the modified object by changing a first attribute of the object corresponding to the first text to a second attribute corresponding to the second text.

20. An operating method of an electronic device, the operating method comprising:
providing an image and texts that describe the image;
changing a first text, included in the texts, to a second text based on a user input; and
providing a modified image in which an object is generated, removed, or modified based on the second text.
